(19) United States
(12) Patent Application Publication
(10) Pub. No.: US 2016/0099511 A1
(43) Pub. Date: Apr. 7, 2016

(54) ELECTRICAL CONNECTOR

(71) Applicant: Daiichi-Seiko Co., Ltd., Kyoto-shi (JP)

(72) Inventor: Kosuke Ozeki, Ogori-shi (JP)

(21) Appl. No.: 14/850,748

(22) Filed: Sep. 10, 2015

(30) Foreign Application Priority Data
Oct. 3, 2014 (JP) 2014-204906

(51) Int. Cl. H01R 12/70

(52) U.S. Cl. CPC H01R 12/7076

(57) ABSTRACT

A housing 11 comprises a lower receiver 11a extending from the back to front of a loading slot 15 and comprising a flat plate-like mounting surface Sa extending in the array direction of lower beams and on which the lower beams are mounted. Furthermore, the housing 11 comprises ribs 11b provided on the mounting surface Sa and extending from the back to front of the loading slot 15 to form grooves Za for retaining the lower beams. The ends of the ribs 11b that are situated in the front of the loading slot 15 are disposed closer to the back of the loading slot 15 than the end of the lower receiver 11a that is situated in the front of the loading slot 15.

### CROSS-REFERENCE TO RELATED APPLICATION

This application claims the benefit of Japanese Patent Application No. 2014-204906, filed on Oct. 3, 2014, the entire disclosure of which is incorporated by reference herein.

### FIELD

This application relates generally to an electrical connector having contacts that make contact with and are connected to signal terminals provided on a plate-like signal transfer member such as a flexible printed circuit (FPC) and flexible flat cable (FFC) for electrically coupling the signal terminals on the signal transfer member to other electrical parts, being of the type into which a signal transfer member is loaded, and mounted on a wiring board or the like.

### BACKGROUND

In order to electrically connect a relatively small signal transfer member such as an FPC and FFC mounted on various kinds of electronic devices to an wiring board on which various electrical parts are mounted, an electrical connector electrically connected and fixed to (mounted on) the wiring board is often used.

With the electrical connector mounted on such a wiring board, when the connection part of a contact made of a conductive material and constituting the electrical connector (the part to be, for example, soldered to an electrode on the wiring board on which the electrical connector is mounted) and the housing wall surface made of an insulating material and facing the connection part are closely spaced, solder or flux may run between the connection part and housing wall surface while the wiring board and connection part are reflow-soldered. The same phenomenon occurs when the lower beam extending from the connection part and the housing wall surface facing the lower beam are closely spaced. The solder or flux may run between the lower beam and housing wall surface.

Furthermore, the solder or flux may run between the coupling part coupling the lower beam to the upper beam facing the lower beam and the housing wall surface facing the coupling part, run between the upper beam and the housing wall surface facing the upper beam, and adhere to the signal contact part provided on the upper beam (the part that can make contact with a signal terminal on the signal transfer member).

Here, the flux contains natural plant resins, such as pine resin, dissolving before the solder and removing oxides and contaminants on the fused solder surface and metal portion.

As the flux adheres to the signal contact part, the conduction between the signal contact part and the signal terminal on the signal transfer member is impaired. As an electrical connector that can prevent such a problem, for example, the connector described in Patent Literature 1 is known.

In the electrical connector described in the Patent Literature 1, the distance between the connection part and the housing wall surface facing the connection part is larger than the distance between the lower beam and the housing wall surface facing the lower beam (for example, see FIG. 11 of the Patent Literature 1). This structure prevents the solder or flux from running between the connection part and housing wall surface, in other words prevents the capillary action from occurring between the connection part and housing wall surface.

In the electrical connector described in the Patent Literature 1, the solder or flux does not run between the connection part and housing wall surface and thus the solder or flux does not run between the lower beam and housing wall surface, either. Therefore, the electrical connector described in the Patent Literature 1 can prevent the flux from adhering to the signal contact part.

### CITATION LIST

### Patent Literature

Patent Literature 1: Unexamined Japanese Patent Application Kokai Publication No. 2009-81073.

### SUMMARY

In the electrical connector described in the Patent Literature 1 and the like, along with the demand for overall downsizing of electrical parts, efforts have been made to reduce the pitch of contacts having an upper beam and a lower beam (smaller pitches). Accordingly, efforts have been made to reduce the distance between the connection part and the housing wall surface facing the connection part and the distance between a contact and the housing wall surface facing the contact.

With the above reduction, in the electrical connector described in the Patent Literature 1, the distance between the connection part and the housing wall surface and the distance between a contact and the housing wall surface are small enough for the solder or flux to run. In other words, the distance is small enough to cause the capillary action. Therefore, the electrical connector described in the Patent Literature 1 has a problem that it may fail to prevent the flux from adhering to the signal contact part in the event that the above reduction is made.

The present disclosure is made with the view of the above circumstance and an objective of the disclosure is to make it possible to prevent the flux from adhering to the signal contact part even if the pitch of contacts is reduced.

### Solution to Problem

In order to achieve the above objective, the electrical connector according to the present disclosure comprises:

an insulating housing comprising a loading slot into which a plate-like signal transfer member can be loaded; and

a plurality of conductive contacts each comprising an upper beam extending from the back to front of the loading slot and comprising a signal contact part that can make contact with a signal terminal situated on one side of the signal transfer member loaded in the housing and a lower beam extending from the back to front of the loading slot, facing the upper beam to be able to clamp the signal transfer member in collaboration with the upper beam, and comprising at the end situated in the front of the loading slot a connection part that is entirely exposed and can be connected to a substrate,

wherein the housing comprises:

a lower receiver extending from the back to front of the loading slot and comprising a flat plate-like mounting surface extending in the array direction of the lower beams and on which the lower beams are mounted; and

ribs provided on the mounting surface and extending from the back to front of the loading slot to form grooves for retaining the lower beams, and

the ends of the ribs that are situated in the front of the loading slot are disposed closer to the back of the loading slot than the end of the lower receiver that is situated in the front of the loading slot.

Furthermore, it is possible that:

the lower beam comprises:

a lower long beam mounted on the mounting surface and extending from the back to front of the loading slot; and

a bend disposed between the end of the lower long beam that is situated in the front of the loading slot and the connection part and of which the surface facing the mounting surface is bent toward the upper beam for being spaced from the mounting surface, and

the ends of the ribs that are situated in the front of the loading slot are disposed closer to the back of the loading slot than the connection point between the lower long beam and bend.

Furthermore, it is possible that:

the bend extends beyond the end of the lower receiver that is situated in the front of the loading slot so that the connection part is disposed away from the end of the lower receiver that is situated in the front of the loading slot.

Furthermore, it is possible that:

the contacts are first contacts inserted into the housing from the loading slot by being shifted from the front to back of the loading slot and of which the lower beams are retained in the grooves formed by the ribs, and

second contacts each comprising an upper beam extending from the back to front of the loading slot and comprising a signal contact part that can make contact with a signal terminal situated on one side of the signal transfer member loaded in the housing and a lower beam extending from the back to front of the loading slot, facing the upper beam to be able to clamp the signal transfer member in collaboration with the upper beam, and comprising at the end situated in the back of the loading slot a connection part that can be connected to a substrate, and each inserted into the housing from an insertion opening on the opposite side to the loading slot by being shifted from the back to front of the loading slot, and of which the lower beams are retained in the grooves formed by the ribs are further provided, and

the ends of the ribs that are situated in the front of the loading slot are disposed closer to the back of the loading slot than the ends of the lower beams of the second contacts.

Furthermore, an actuator movably attached to the housing, comprising abutters configured to be able to abut on the contacts, and making the signal contact part and signal terminal contact by pressing the contacts as the abutters move is provided.

Furthermore, it is possible that:

the contacts have a nearly H-shaped contour comprising a coupler coupling the upper beam and lower beam,

the abutters each comprise a cam section where a cam is formed,

the cam section is clamped by the upper beam and lower beam situated in the back of the loading slot with respect to the coupler as the boundary, and

the actuator pushes up the upper beam in the back of the loading slot with the cam section as the cam section rotates, whereby the upper beam in the front of the loading slot with respect to the coupler as the boundary swings to make the signal contact part and signal terminal contact.

According to the present disclosure, the ends of the ribs forming the grooves for retaining the lower beams that are situated in the front of the loading slot are disposed closer to the back of the loading slot than the end of the lower receiver having the mounting surface on which the lower beams are mounted that is situated in the front of the loading slot. Therefore, it is possible to prevent the solder or flux from running between the lower beam and rib even if the solder or flux runs along the connection part and runs between the lower beam and the mounting surface of the lower receiver while, for example, the connection part is soldered to an electrode on the substrate. In other words, it is possible to prevent the capillary action from occurring between the lower beam and rib.

Therefore, according to the present disclosure, it is possible to prevent the flux from adhering to the signal contact part of the upper beam and there is no need of spacing the members in the pitch direction of the contacts, whereby prevention of adhering of the flux can be realized even if the pitch of contacts is reduced.

### BRIEF DESCRIPTION OF THE DRAWINGS

A more complete understanding of this application can be obtained when the following detailed description is considered in conjunction with the following drawings, in which:

FIG. 1 is a perspective view of the electrical connector according to an embodiment of the present disclosure and a signal transfer member when seen from the loading slot side;

FIG. 2 is a plan view of the electrical connector of the present disclosure;

FIG. 3 is a cross-sectional view at the line A-A of the electrical connector shown in FIG. 2;

FIG. 4 is a cross-sectional view at the line B-B of the electrical connector shown in FIG. 2;

FIG. 5 is a cross-sectional view at the line C-C of the electrical connector shown in FIG. 2;

FIG. 6A is a plan view of the electrical connector with the signal transfer member loaded in the loading slot;

FIG. 6B is a cross-sectional view at the line D-D of the electrical connector shown in FIG. 6A;

FIG. 6C is a cross-sectional view at the line E-E of the electrical connector shown in FIG. 6A;

FIG. 7 is a cross-sectional view at the line F-F of the electrical connector shown in FIG. 2; and

FIG. 8 is a cross-sectional view at the line G-G of the electrical connector shown in FIG. 2.

### DETAILED DESCRIPTION

An electrical connector 10 according to an embodiment of the present disclosure will be described hereafter. Here, in each figure, a Cartesian coordinate system of which the x-axis direction, y-axis direction, and z-axis direction coincide with the lateral direction, longitudinal direction, and thickness direction of the electrical connector 10, respectively, is set and made reference to as needed. Furthermore, the arrowed direction of each axis is referred to with the + (plus) sign and the opposite direction is referred to with the − (minus) sign.

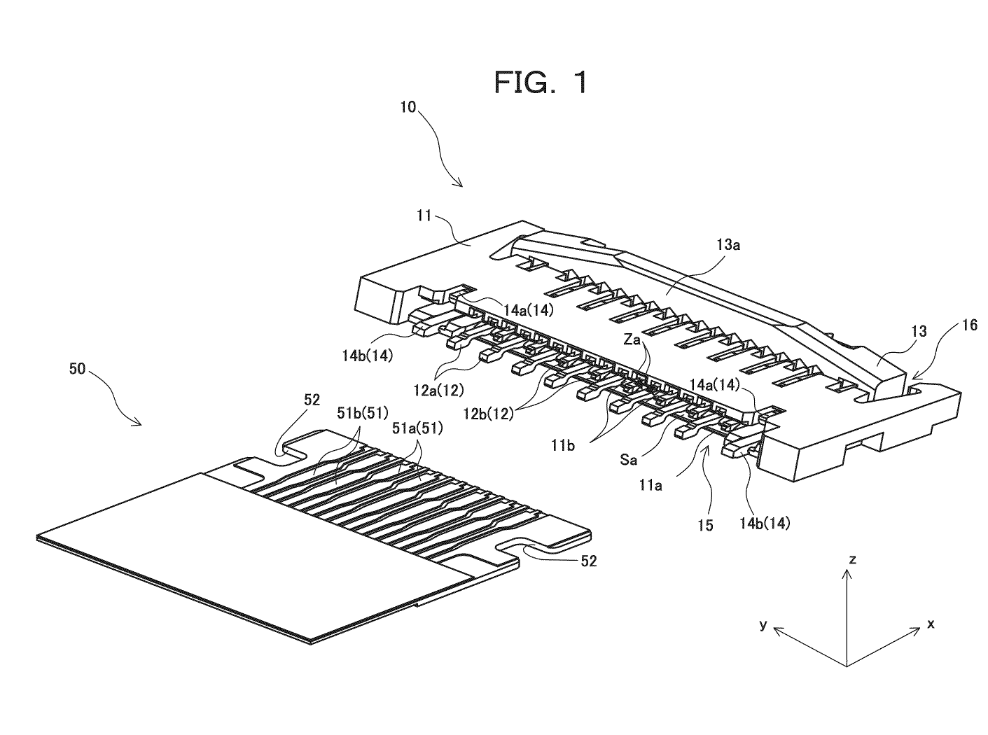

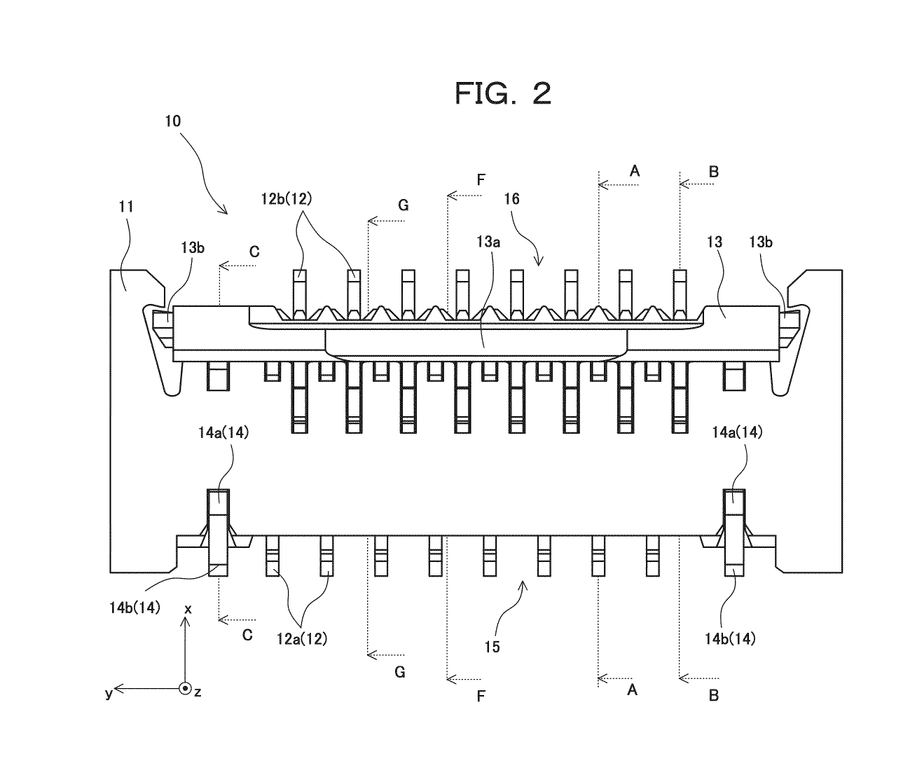

As shown in FIGS. 1 and 2, the electrical connector 10 comprises a nearly rectangular housing 11, multiple contacts 12 disposed in the housing 11, an actuator 13 rotatably attached to the housing 11, and locks 14 disposed on either longitudinal end of the housing 11.

The housing 11 is made of an insulating material such as a resin and disposed on a wiring board of, for example, an electronic device or the like. The housing 11 has a loading slot 15 into which an FPC 50, which is an exemplary plate-like signal transfer member, can be loaded. The loading slot 15 has a large opening in the front and a small opening in the back.

Furthermore, the housing 11 comprises a lower receiver 11a extending from the back to front of the loading slot 15 and having a flat plate-like mounting surface Sa extending in the array direction of the contacts 12 and on which the contacts 12 are mounted.

Furthermore, the housing 11 comprises ribs 11b provided on the mounting surface Sa of the lower receiver 11a and extending from the back to front of the loading slot 15 so as to form grooves Za in the form of a corresponding recess for retaining the multiple contacts 12.

The FPC 50 that is to be loaded in the loading slot 15 of the housing 11 has electrodes 51 connected to the wiring. The electrodes 51 comprise first electrodes 51a provided at one end of the FPC 50 and second electrodes 51b provided away from the one end of the FPC 50. Furthermore, the FPC 50 has notches 52 that are to be locked on the locks 14.

The contacts 12 are each a conductor made of a metal plate or the like and elastic. The contacts 12 comprise first contacts 12a disposed at positions corresponding to the first electrodes 51a of the FPC 50 loaded in the housing 11. Furthermore, the contacts 12 comprise second contacts 12b disposed at positions corresponding to the second electrode 51b of the FPC 50 loaded in the housing 11.

In assembling the electrical connector 10 (before the actuator 13 is attached to the housing 11), the first contacts 12a are inserted into the housing 11 from the loading slot 15 by being shifted from the front to back of the loading slot 15.

On the other hand, in assembling the electrical connector 10 (before the actuator 13 is attached to the housing 11), the second contacts 12b are inserted into the housing 11 from an insertion opening 16 that is on the opposite side to the loading slot 15 by being shifted from the back to front of the loading slot 15.

At this point, the first contacts 12a and second contacts 12b are inserted in the grooves Za and the like of the housing 11 and thereby fixed to the housing 11. The first contacts 12a and second contacts 12b are disposed alternately in the longitudinal direction of the housing 11 (the y-axis direction).

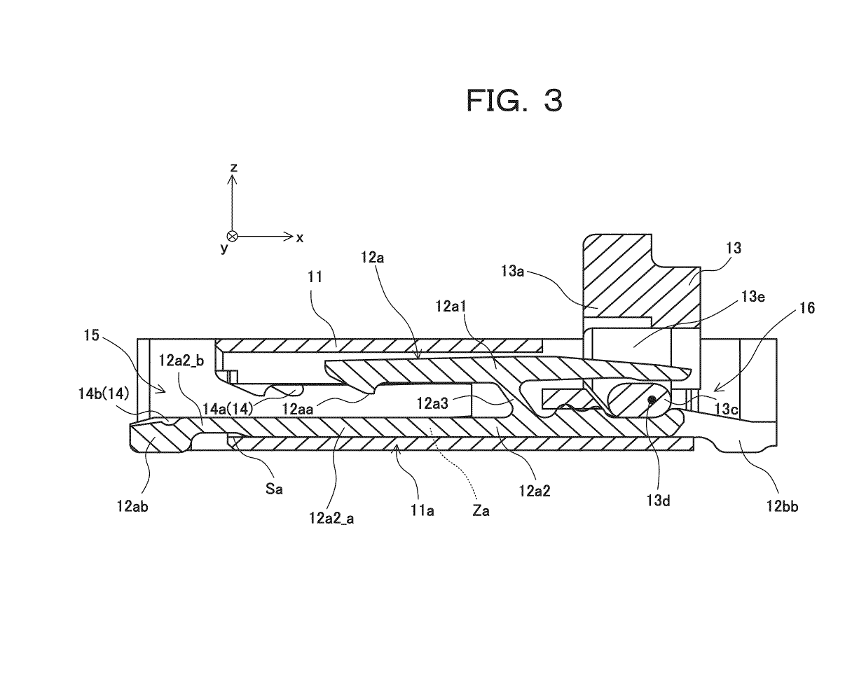

The first contacts 12a each comprise, as shown in FIG. 3 (a cross-sectional view at the line A-A shown in FIG. 2), a pair of beams 12a1 and 12a2 (an upper beam 12a1 and a lower beam 12a2 longer than the upper beam 12a1).

The upper beam 12a1 and lower beam 12a2 extend from the back to front of the loading slot 15. The upper beam 12a1 comprises a first signal contact part 12aa so disposed at the end situated in the front of the loading slot 15 as to be able to make contact with a first electrode 51a.

The lower beam 12a2 faces the upper beam 12a1 so as to be able to clamp the FPC 50 loaded in the housing 11 in collaboration with the upper beam 12a1. The lower beam 12a2 comprises a first connection part 12ab that is soldered to an electrode on the wiring board of, for example, an electronic device or the like at the end situated in the front of the loading slot 15. The first connection part 12ab is entirely exposed except for the connection surface.

Furthermore, the lower beam 12a2 comprises a lower long beam 12a2_{—}a mounted on the mounting surface Sa of the lower receiver 11a and extending from the back to front of the loading slot 15. The lower long beam 12a2_{—}a is retained in a groove Za formed by the ribs 11b.

Furthermore, the lower beam 12a2 comprises a bend 12a2_{—}b disposed between the end of the lower long beam 12a2_{—}a that is situated in the front of the loading slot 15 and the first connection part 12ab and of which the surface facing the mounting surface Sa is bent toward the upper beam 12a1 for being spaced from the mounting surface Sa.

The above-described first contacts 12a each comprise a pillar 12a3 connecting the upper beam 12a1 and lower beam 12a2. With the upper beam 12a1 and lower beam 12a2 being connected by the pillar 12a3, the first contacts 12a have a nearly H-shaped contour.

The pair of beams (the upper beam 12a1 and lower beam 12a2) situated on one side of each first contact 12a with respect to the pillar 12a3 as the boundary is disposed on the inner periphery of the loading slot 15 of the housing 11 and the first signal contact part 12aa is protruded in part.

Furthermore, the pair of beams (the upper beam 12a1 and lower beam 12a2) situated on the other side of each first contact 12a with respect to the pillar 12a3 as the boundary is disposed on the side of the housing 11 closer to the insertion opening 16. Then, the upper beam 12a1 is exposed from the housing 11.

A cam section 13c, which is ellipsoidal in cross-section, of the actuator 13 described later is positioned between the pair of beams (the upper beam 12a1 and lower beam 12a2) situated on the other side of each first contact 12a.

As the pair of beams situated on the other side of each first contact 12a retains a cam section 13c of the actuator 13, the actuator 13 can rotate with respect to the housing 11. Thus, the cam section 13c can rotate about the axis 13d in accord with the rotation of the actuator 13. Furthermore, the upper beam 12a1 situated on the other side of each first contact 12a is inserted in a slit 13e formed directly above the cam section 13c.

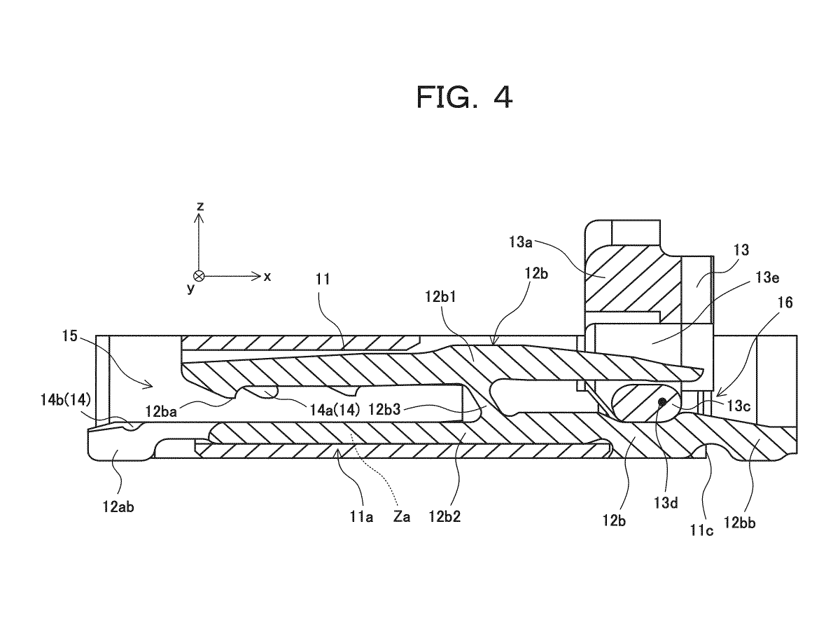

Subsequently, as shown in FIG. 4, the second contacts 12b each comprise a pair of beams 12b1 and 12b2 (an upper beam 12b1 and a lower beam 12b2 longer than the upper beam 12b1).

The upper beam 12b1 and lower beam 12b2 extend from the back to front of the loading slot 15. The upper beam 12b1 comprises a second signal contact part 12ba so disposed at the end situated in the front of the loading slot 15 as to be able to make contact with a second electrode 51b.

The lower beam 12b2 faces the upper beam 12b1 so as to be able to clamp the FPC 50 loaded in the housing 11 in collaboration with the upper beam 12b1. The lower beam 12b2 is retained in a groove Za formed by the ribs 11b.

Furthermore, the lower beam 12b2 comprises a second connection part 12bb that is soldered to an electrode on the wiring board of, for example, an electronic device or the like at the end closer to the insertion opening 16 of the housing 11 (at the end situated in the back of the loading slot 15).

The above-described second contacts 12b each comprise a pillar 12b3 connecting the upper beam 12b1 and lower beam 12b2. With the upper beam 12b1 and lower beam 12b2 being connected by the pillar 12b3, the second contacts 12b have a nearly H-shaped contour.

The pair of beams (the upper beam 12b1 and lower beam 12b2) situated on one side of each second contact 12b with respect to the pillar 12b3 as the boundary is disposed on the inner periphery of the loading slot 15 of the housing 11 and the second signal contact part 12ba is protruded in part.

Furthermore, the pair of beams (the upper beam 12b1 and lower beam 12b2) situated on the other side of each second contact 12b with respect to the pillar 12a3 as the boundary is disposed on the side of the housing 11 closer to the insertion opening 16. Additionally, the upper beam 12b1 is exposed from the housing 11. Like the first contacts 12a, a cam section 13c of the actuator 13 is disposed between this pair of beams (the upper beam 12b1 and lower beam 12b2). As a result, the cam section 13c of the actuator 13 is retained by the pair of beams situated on the other side of the second contact 12b.

The actuator 13 is, for example, as shown in FIGS. 1 and 2, disposed on the side of the housing 11 closer to the insertion opening 16 (the side opposite to the loading slot 15). The actuator 13 comprises an operator 13a extending along the longitudinal direction of the housing 11 (the y-axis direction). Furthermore, the actuator 13 comprises, as shown in FIG. 2, abutters 13b disposed on either longitudinal end of the operator 13a. The operator 13a is disposed with its longitudinal direction nearly coinciding with the longitudinal direction of the housing 11.

The abutters 13b are housed in recesses formed in the lateral ends of the housing 11. As a result, the actuator 13 is attached to the housing 11 and the recesses function as a retainer for the housing 11 in the case of the actuator 13 receiving an unexpected force.

Furthermore, as shown in FIGS. 3 and 4, the actuator 13 is integrally provided with the multiple cam sections 13c integrally extending from the abutters 13b via the slit 13e, operating the first contacts 12a and second contacts 12b, and having a cross-section comprising orthogonal short and long sides. As described above, the cam sections 13c are retained by the pairs of beams (the upper beam 12a1 and lower beam 12a2) situated on the other side of the first contacts 12a and the pairs of beams (the upper beam 12b1 and lower beam 12b2) situated on the other side of the second contacts 12b.

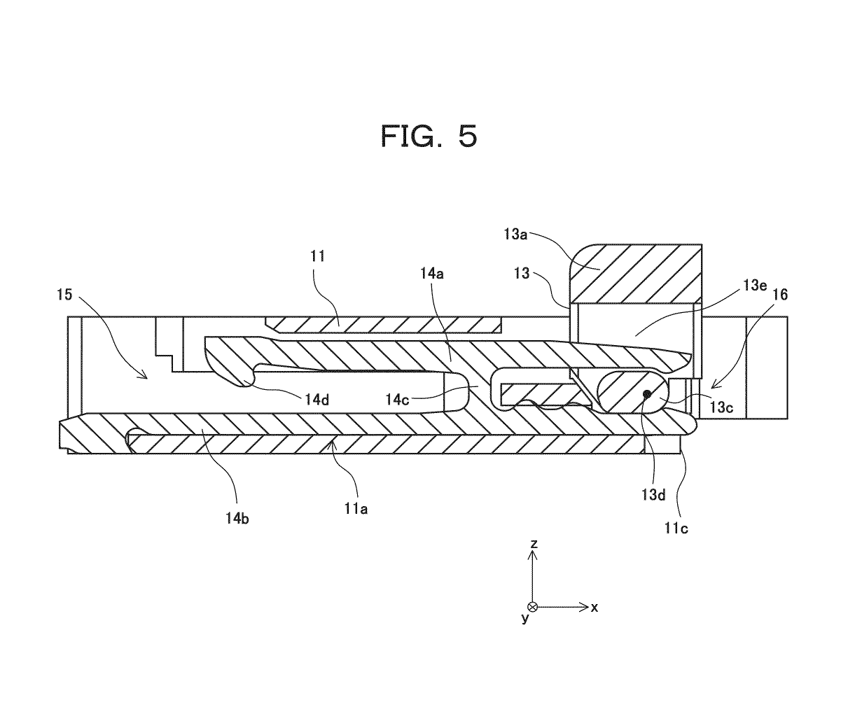

Furthermore, the cam sections 13c are configured to be able to make contact with the locks 14 as well. The locks 14 each comprise, like the first contacts 12a and second contacts 12b, a pair of beams 14a and 14b (an upper beam 14a and a lower beam 14b longer than the upper beam 14a) as shown in FIG. 5 (a cross-sectional view at the line C-C shown in FIG. 2).

Furthermore, the locks 14 each comprise a pillar 14c connecting the upper beam 14a and lower beam 14b. With the upper beam 14a and lower beam 14b being connected by the pillar 14c, the locks 14 have a nearly H-shaped contour like the first contacts 12a and second contacts 12b.

The pair of beams situated on one side of each lock 14 with respect to the pillar 14c as the boundary is disposed on the inner periphery of the loading slot 15 of the housing 11. Of the pair of beams situated on the one side of each lock 14, the upper beam 14a is provided at the end with a claw 14d that is a protrusion for locking in a notch 52 of the FPC 50.

Furthermore, a cam section 13c of the actuator 13 is disposed between the pair of beams (the upper beam 14a and lower beam 14b) situated on the other side of each lock 14 with respect to the pillar 14c as the boundary (the side closer to the insertion opening 16). As a result, the cam sections 13c are retained by the pairs of beams situated on the other side of the locks 14 as well.

The connection operation of the electrical connector 10 comprising the above-described members will be described. It is assumed that at least the first connation parts 12ab and second connection parts 12bb are already soldered to electrodes on the wiring board in the electrical connector 10. In the electrical connector 10, when the actuator 13 is in the opened state (the actuator 13 is nearly perpendicular to the loading direction of the FPC 50), for example, as shown in FIGS. 3 to 5, the pairs of beams of the first contacts 12a, second contacts 12b, and locks 14 each clamp a cam section 13c at two points forming a short side in a cross-section.

As a result, the distance between each pair of beams of the first contacts 12a, second contacts 12b, and locks 14 is larger than when the actuator 13 is in the locked state (larger than when the actuator 13 is nearly horizontal to the loading direction of the FPC 50). At this point, the distance between the pair of beams situated on the one side of each first contact 12a and the distance between the pair of beams situated on the one side of each second contact 12b are larger than when the actuator 13 is in the locked state.

Therefore, the contacts 12 apply no or marginal contact pressure to the FPC 50 and thus the user can load the FPC 50 into the loading slot 15 of the housing 11 to house the FPC 50 in the housing 11 (move in the +x direction).

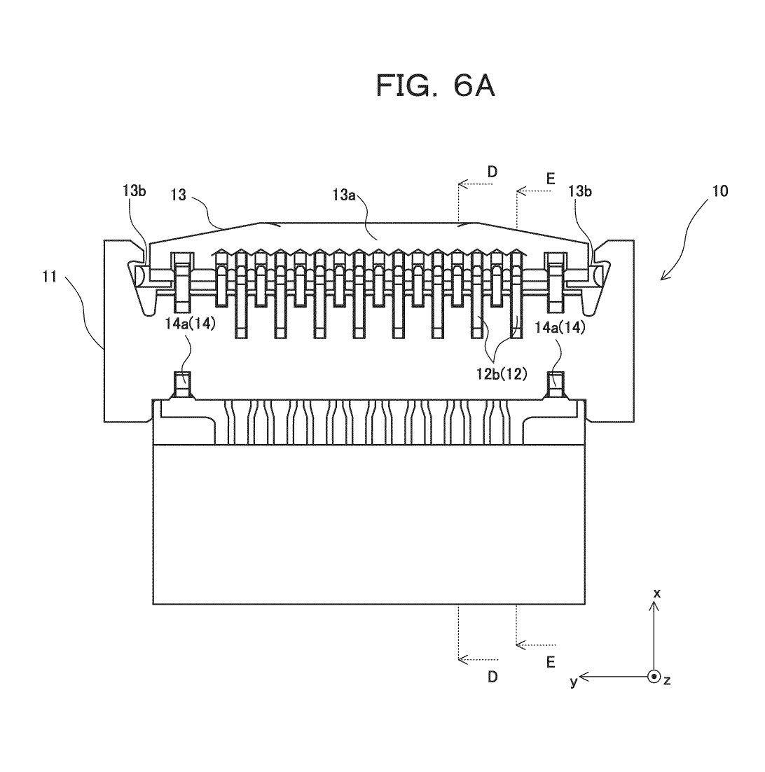

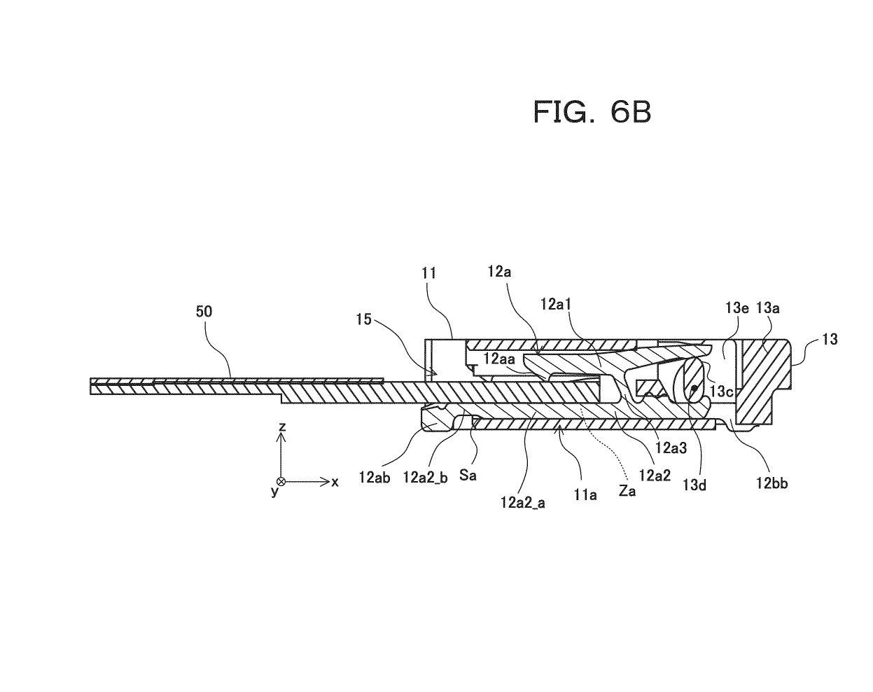

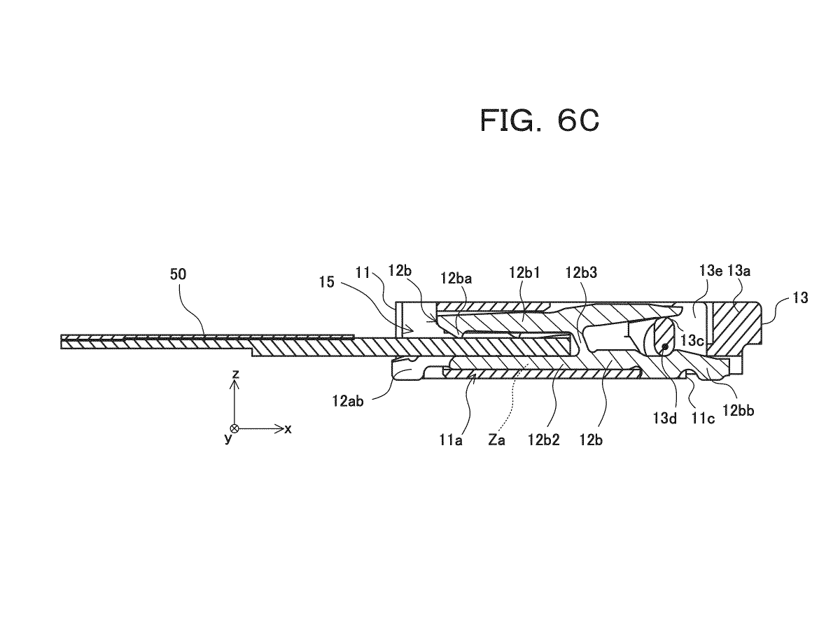

As the operator rotates the opened actuator 13, the actuator 13 becomes nearly horizontal to the loading direction of the FPC 50, namely is locked, as shown in FIGS. 6A to 6C. While the actuator 13 is rotated from the opened state to the locked state, the cam sections 13c of the actuator 13 rotate about the axis 13d.

When the actuator 13 is in the locked state, as shown in FIG. 6B (a cross-sectional view at the line D-D shown in FIG. 6A), the pair of beams (the upper beam 12a1 and lower beam 12a2) situated on the other side of each first contact 12a clamps the cam section 13c at two points forming a long side in a cross-section. As a result, the upper beam 12a1 situated on the other side of each first contact 12a is pushed up.

Similarly, when the actuator 13 is in the locked state, as shown in FIG. 6C (a cross-sectional view at the line E-E shown in FIG. 6A), the pair of beams (the upper beam 12b1 and lower beam 12b2) situated on the other side of each second contact 12b clamps the cam section 13c at two points forming a long side in a cross-section. As a result, the upper beam 12b1 situated on the other side of each second contact 12b is pushed up.

Then, the upper beam 12a1 situated on the one side of each first contact 12a and the upper beam 12b1 situated on the one side of each second contact 12b swing. At this point, the distance between the pair of beams situated on the one side of each first contact 12a and the distance between the pair of beams situated on the one side of each second contact 12b are smaller than when the actuator 13 is in the opened state. Therefore, the first signal contact part 12aa and first electrode 51a make contact and so do the second signal contact part 12ba and second electrode 51b (the contacts 12 apply contact pressure to the FPC 50).

Furthermore, when the actuator 13 is in the locked state, the pair of beams (the upper beam 14a and lower beam 14b) situated on the other side of each lock 14 also clamps the cam section 13c at two points forming a long side in a cross-section.

Then, the upper beam 14a situated on the one side of each lock 14 swings. At this point, the distance between the pair of beams (the upper beam 14a and lower beam 14b) situated on the one side of each lock 14 is smaller than when the actuator 13 is in the opened state. Thus, the claw 14d provided on the upper beam 14a situated on the one side of each lock 14 is locked in the notch 52. Therefore, the FPC 50 is housed in place within the housing 11 and restricted in motion in the −x direction that is the removal direction of the FPC 50, whereby the FPC 50 is completely housed in the housing 11 and the first electrodes 51a and second electrodes 51b of the FPC 50 and the electrodes on the wiring board corresponding to those electrodes are connected.

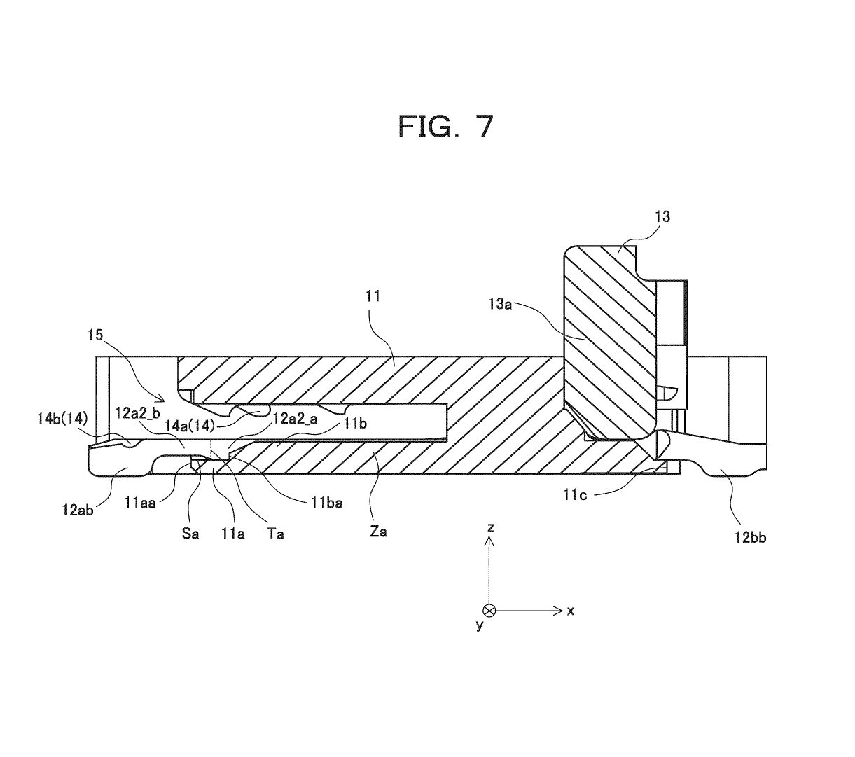

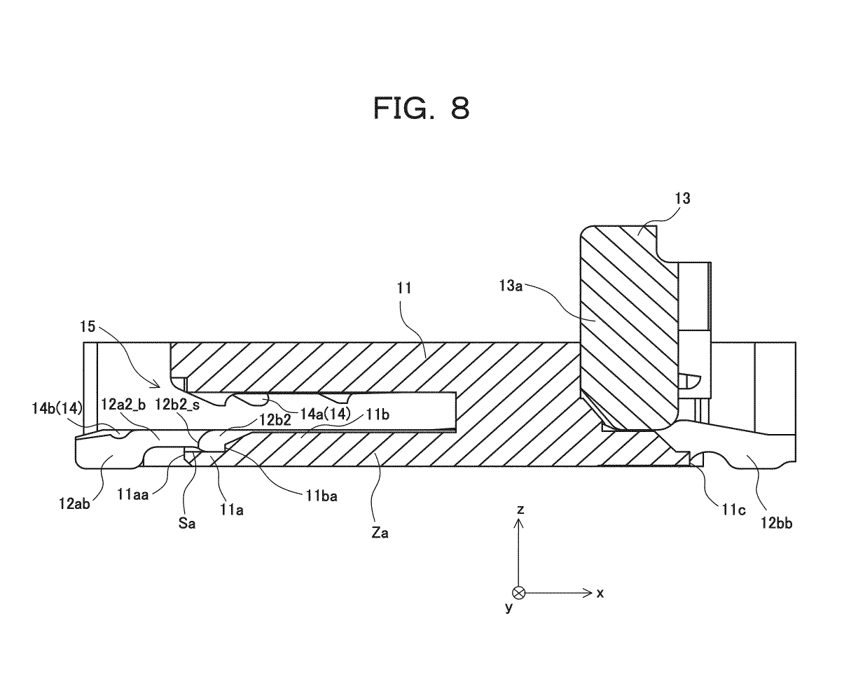

The efficacy of the present disclosure in the above-described electrical connector 10 will be described. As shown in FIG. 7 (a cross-sectional view at the line F-F shown in FIG. 2) and FIG. 8 (a cross-sectional view at the line G-G shown in FIG. 2), the bend 12a2_{—}b extends beyond the end 11aa of the lower receiver 11a so that the first connection part 12ab is situated away from the end 11aa of the lower receiver 11a that is situated in the front of the loading slot 15.

Then, the first connection part 12ab can be disposed as much away from the end 11aa of the lower receiver 11a as possible. Furthermore, the first connection part 12ab can entirely be exposed.

As a result, when the first connection part 12ab is soldered, for example, to an electrode on the wiring board, it is possible to prevent the solder or flux from reaching between the lower long beam 12a2_{—}a and the mounting surface Sa of the lower receiver 11a. Thus, it is possible to prevent the solder or flux from running between the lower long beam 12a2_{—}a and the inner wall surfaces of the ribs 11b. Therefore, it is possible to prevent the flux from adhering to the first signal contact part 12aa of the upper beam 12a1.

Here, like the first connection part 12ab, the second connection part 12bb is also disposed away from the end 11c of the housing 11 where the insertion opening 16 is situated. Furthermore, the second connection part 12bb is also entirely exposed. Then, when the second connection part 12bb is soldered, for example, to an electrode on the wiring board, it is possible to prevent the solder or flux from running between the lower beam 12b2 and the inner wall surfaces of the ribs 11b. Therefore, it is possible to prevent the flux from adhering to the second signal contact part 12ba of the upper beam 12b1.

Furthermore, in the electrical connector 10, the end 11ba of each rib 11b that is situated in the front of the loading slot 15 is, as shown in FIG. 7, closer to the back of the loading slot 15 than the connection point Ta between the lower long beam 12a2_{—}a and bend 12a2_{—}b.

Here, in the portion preceding the connection point Ta (the portion closer to the front of the loading slot 15), the surface of the bend 12a2-b facing the mounting surface Sa is bent toward the upper beam 12a1. Therefore, the distance between the bend 12a2_{—}b and mounting surface Sa is larger than the distance between the lower long beam 12a2_{—}a and mounting surface Sa. Furthermore, the entire surface of the bend 12a2_{—}b is exposed.

As a result, when the first connection part 12ab is soldered, for example, to an electrode on the wiring board, it is possible to prevent the solder or flux having adhered to the first connection part 12ab from reaching between the lower long beam 12a2_{—}a and the mounting surface Sa of the lower receiver 11a. Then, it is possible to prevent the solder or flux from running between the lower long beam 12a2_{—}a and the mounting surface Sa. Therefore, it is possible to prevent the flux from adhering to the first signal contact part 12aa of the upper beam 12a1.

Furthermore, in the electrical connector 10, the ribs 11b forming the grooves Za for retaining the lower beams 12a2 and 12b2 are provided on the mounting surface Sa of the lower receiver 11a on which the lower beams 12a2 and 12b2 are mounted, and formed integrally with the housing 11.

Here, the end 11ba of each rib 11b that is situated in the front of the loading slot 15 is disposed closer to the back of the loading slot 15 than the end 11aa of the lower receiver 11a that is situated in the front of the loading slot 15. Therefore, the portion of the lower long beam 12a2_{—}a that is exposed from the end 11ba is faced only with the mounting surface Sa.

Then, when the first connection part 12ab is soldered, for example, to an electrode on the wiring board, it is possible to suppress the solder or flux running between the lower long beam 12a2_{—}a and mounting surface Sa and running between the lower long beam 12a2_{—}a and the inner wall surfaces of the ribs 11b. In other words, it is possible to prevent the capillary action from occurring between the lower long beam 12a2_{—}a and the inner wall surfaces of the ribs 11b. Therefore, it is possible to prevent the solder or flux from adhering to the first signal contact part 12aa of the upper beam 12a1.

Furthermore, the end 11ba of each rib 11b that is situated in the front of the loading slot 15 is, as shown in FIG. 8, closer to the back of the loading slot 15 than the end 12b2_{—}s of the lower beam 12b2 of each second contact 12b.

Here, the ribs 11b are required only to be capable of retaining the ends of the lower beams 12a2 and 12b2 in place in the direction along which the contacts 12a and 12b arrayed. Therefore, the end 12b2_{—}s of each lower beam 12b2 may be exposed from the end 11ba of each rib 11b.

As just mentioned, the end 11ba of each rib 11b can be disposed closer to the back of the loading slot 15 to the extent that the end 12b2_{—}s of each lower beam 12b2 is exposed. As a result, when the first connection part 12ab is soldered, for example, to an electrode on the wiring board, the effect of preventing the solder or flux from running between the lower beam 12b2 and the inner wall surfaces of the ribs 11b becomes further prominent.

As described above, in the electrical connector 10 of this embodiment, the end 11ba of each rib 11b that is situated in the front of the loading slot 15 is disposed closer to the back of the loading slot 15 than the end 11aa of the lower receiver 11a that is situated in the front of the loading slot 15.

Therefore, when the first connection part 12ab is soldered, for example, to an electrode on the wiring board, it is possible to prevent the solder or flux from running between the lower long beam 12a2_{—}a and the inner wall surfaces of the ribs 11b even if the solder or flux runs between lower long beam 12a2_{—}a and the mounting surface Sa of the lower receiver 11a for some reason.

Therefore, the electrical connector 10 of this embodiment can prevent the flux from adhering to the first signal contact part 12aa of the upper beam 12a1.

Furthermore, according to the electrical connector 10 of this embodiment, like the first connection part 12ab, the second connection part 12bb is also disposed away from the end 11c of the housing 11 where the insertion opening 16 is situated. Furthermore, the second connection part 12bb is also entirely exposed. Then, when the second connection part 12bb is soldered, for example, to an electrode on the wiring board, it is possible to prevent the solder or flux from running between the lower beam 12b2 and the inner wall surfaces of the ribs 11b. Therefore, it is possible to prevent the flux from adhering to the second signal contact part 12ba of the upper beam 12b1.

Furthermore, according to the electrical connector 10 of this embodiment, there is no need of spacing the members in the array direction of the contacts 12a and 12b. Therefore, the above-described prevention of adhering of the flux can be realized even if the pitch of the contacts 12a and 12b is reduced.

Furthermore, with the electrical connector 10 of this embodiment, it is possible to prevent the solder or flux from running between the lower long beam 12a2_{—}a and the inner wall surfaces of the ribs 11b and between the lower beam 12b2 and the inner wall surfaces of the ribs 11b, whereby there is no need of forming through-holes at the lower receiver 11a to discharge the solder or flux. Then, there is no need of providing areas where any wiring is prohibited on the wiring board on which the electrical connector 10 is mounted. Therefore, the electrical connector 10 of this embodiment allows for effective use of the wiring board.

An embodiment of the present disclosure is described above. The present disclosure is not confined to the above-described embodiment and various modifications and applications are available.

For example, in the electrical connector 10 of the above-described embodiment, the actuator 13 is of the type rotating with respect to the housing 11. This is not restrictive. The actuator may be of the type sliding with respect to the housing 11.

In such a case, the actuator is attached to the housing 11 slidably from a point closer to the loading slot 15 to a point closer to the insertion opening 16 and from the point closer to the insertion opening 16 to the point closer to the loading slot 15.

When the above actuator is moved to the point closer to the loading slot 15, the actuator abuts on and presses the upper beam 12a1 situated on the one side of each first contact 12a with respect to the pillar 12a3 as the boundary and the upper beam 12b1 situated on the one side of each second contact 12b with respect to the pillar 12b3 as the boundary.

As a result, the upper beam 12a1 situated on the one side of each first contact 12a and the upper beam 12b1 situated on the one side of each second contact 12b swing. At this point, the distance between the pair of beams situated on the one side of each first contact 12a and the distance between the pair of beams situated on the one side of each second contact 12b are smaller than when the actuator is moved to the point closer to the insertion opening 16. Therefore, the first signal contact part 12aa and first electrode 51a make contact and so do the second signal contact part 12ba and second electrode 51b.

On the other hand, when the above actuator is moved to the point closer to the insertion opening 16, the actuator no longer abuts on the upper beam 12a1 situated on the one side of each first contact 12a with respect to the pillar 12a3 as the boundary and the upper beam 12b1 situated on the one side of each second contact 12b with respect to the pillar 12b3 as the boundary.

As a result, the upper beam 12a1 situated on the one side of each first contact 12a and the upper beam 12b1 situated on the one side of each second contact 12b return to the unpressed state. At this point, the distance between the pair of beams situated on the one side of each first contact 12a and the distance between the pair of beams situated on the one side of each second contact 12b are larger than when the actuator is moved to the point closer to the loading slot 15. Therefore, the first signal contact part 12aa and second electrode 51a and the second signal contact part 12ba and second electrode 51b are no longer in contact (or are in light contact).

As just mentioned, the electrical connector 10 may comprise an actuator slidable with respect to the housing 11 in place of the actuator 13 rotatable with respect to the housing 11.

Furthermore, in the electrical connector 10 of the above-described embodiment, the end 12b2_{—}s of the lower beam 12b2 of each second contact 12b is exposed from the end 11ba of each rib 11b. This is not restrictive. For example, the end 12b2_{—}s of each lower beam 12b2 may be aligned with the end 11ba of each rib 11b or may be disposed closer to the back of the loading slot 15 than the end 11ba of each rib 11b.

Furthermore, the electrical connector 10 of the above-described embodiment comprises the locks 14. This is not restrictive. In other words, the electrical connector 10 of the above-described embodiment may not comprise the locks 14.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SYMBOLS

10 Electrical connector, 11 Housing, 11a Lower receiver, 11aa, 11ba, 11c, 12b2_{—}s End, 11b Rib, 12 Contact, 12a First contact, 12b Second contact, 12a1, 12b1, 14a Upper beam, 12a2, 12b2, 14b Lower beam, 12a2_{—}a Lower long beam, 12a2_{—}b Bend, 12a3, 12b3, 14c Pillar, 12aa First signal contact part, 12ab First connection part, 12ba Second signal contact part, 12bb Second connection part, 13 Actuator, 13a Operator, 13b Abutter, 13c Cam section, 13d Axis, 13e Slit, 14 Lock, 14d Claw, 15 Loading slot, 16 Insertion opening, 50 FPC, 51 Electrode, 51a First electrode, 51b Second electrode, 52 Notch, Sa Mounting surface, Ta Connection point, Za Groove

What is claimed is:

1. An electronic connector, comprising:
an insulating housing comprising a loading slot into which a plate-like signal transfer member can be loaded; and
a plurality of conductive contacts each comprising an upper beam extending from the back to front of the loading slot and comprising a signal contact part that can make contact with a signal terminal situated on one side of the signal transfer member loaded in the housing and a lower beam extending from the back to front of the loading slot, facing the upper beam to be able to clamp the signal transfer member in collaboration with the upper beam, and comprising at the end situated in the front of the loading slot a connection part that is entirely exposed and can be connected to a substrate,
wherein the housing comprises:
a lower receiver extending from the back to front of the loading slot and comprising a flat plate-like mounting surface extending in the array direction of the lower beams and on which the lower beams are mounted; and
ribs provided on the mounting surface and extending from the back to front of the loading slot to form grooves for retaining the lower beams, and
the ends of the ribs that are situated in the front of the loading slot are disposed closer to the back of the loading slot than the end of the lower receiver that is situated in the front of the loading slot.

2. The electrical connector according to claim 1, wherein
the lower beam comprises:
a lower long beam mounted on the mounting surface and extending from the back to front of the loading slot; and
a bend disposed between the end of the lower long beam that is situated in the front of the loading slot and the connection part and of which the surface facing the mounting surface is bent toward the upper beam for being spaced from the mounting surface, and
the ends of the ribs that are situated in the front of the loading slot are disposed closer to the back of the loading slot than the connection point between the lower long beam and bend.

3. The electrical connector according to claim 2, wherein
the bend extends beyond the end of the lower receiver that is situated in the front of the loading slot so that the connection part is disposed away from the end of the lower receiver that is situated in the front of the loading slot.

4. The electrical connector according to claim 1, wherein
the contacts are first contacts inserted into the housing from the loading slot by being shifted from the front to back of the loading slot and of which the lower beams are retained in the grooves formed by the ribs, and
second contacts each comprising an upper beam extending from the back to front of the loading slot and comprising a signal contact part that can make contact with a signal terminal situated on one side of the signal transfer member loaded in the housing and a lower beam extending from the back to front of the loading slot, facing the upper beam to be able to clamp the signal transfer member in collaboration with the upper beam, and comprising at the end situated in the back of the loading slot a connection part that can be connected to a substrate, and each inserted into the housing from an insertion opening on the opposite side to the loading slot by being shifted from the back to front of the loading slot, and of which the lower beams are retained in the grooves formed by the ribs are further provided, and
the ends of the ribs that are situated in the front of the loading slot are disposed closer to the back of the loading slot than the ends of the lower beams of the second contacts.

5. The electrical connector according to claim 1, comprising:
an actuator movably attached to the housing, comprising abutters configured to be able to abut on the contacts, and making the signal contact part and signal terminal contact by pressing the contacts as the abutters move.

6. The electrical connector according to claim 5, wherein
the contacts have a nearly H-shaped contour comprising a coupler coupling the upper beam and lower beam,
the abutters each comprise a cam section where a cam is formed,
the cam section is clamped by the upper beam and lower beam situated in the back of the loading slot with respect to the coupler as the boundary, and
the actuator pushes up the upper beam in the back of the loading slot with the cam section as the cam section rotates, whereby the upper beam in the front of the loading slot with respect to the coupler as the boundary swings to make the signal contact part and signal terminal contact.
